(19) United States
(12) Patent Application Publication
(10) Pub. No.: US 2004/0122949 A1
(43) Pub. Date: Jun. 24, 2004

(54) System and method for browsing on behalf of others

(76) Inventors: Krystof C. Zmudzinski, Forest Grove, OR (US); Dhananjay V. Keskar, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/329,112

(22) Filed: Dec. 23, 2002

(51) Int. Cl. G06F 15/16; G06F 15/173

(52) U.S. Cl. 709/225; 709/218

(57) ABSTRACT

A system and method for browsing on behalf of others. A browsing device sends a content request to a content server. The content request includes a request for content and/or resources suitable for execution on the target device, a target device profile and a browser profile. The browser profile is for enabling the server to return information regarding the requested content and/or resources for display by a browsing device. The target device profile is for enabling the server to return downloadable content to the browsing device corresponding to the information regarding the requested content and/or resources in a format suitable for execution on the target device. The browsing device receives the information regarding the requested content and/or resources in the form of Web pages, the Web pages comprising one or more of titles, information regarding the titles, video clips, media shots, screen shots, etc. The browsing device enables a user to select the desired content presented on the Web pages. The content server, after receiving the user selection, sends the selected content to the browsing device in a format based on the profile of the target device. The browsing device uploads the received content to the target device during a subsequent sync.

### BACKGROUND OF THE INVENTION

1. Field of the Invention

The present invention is generally related to Internet technology. More particularly, the present invention is related to an apparatus and method for enabling a browsing device to browse the Internet on behalf of another device.

2. Description

Many mobile devices, such as personal digital assistants (PDAs), cell phones, handheld computers, etc., are capable of supporting various kinds of executable and downloadable content. One source for finding such content is the Internet. Mobile devices may typically access such content from the Internet using wireless protocols, such as Wireless Access Protocol (WAP) and its associated markup language, the Wireless Markup Language (WML).

Although mobile devices can access the Internet, the characteristics of mobile devices, such as, relatively slow processor speeds, small memory size, small screen size, and inconvenient input capabilities (i.e., a stylus and/or touchscreen), limit its capability to browse the Web for such content. For example, often times Web sites may provide previews of executable content in the form of video clips. The video clips are typically large files and take a long time to download. Although the mobile device may be able to execute the application, the mobile device may not have the capability to view the video clip. Often times the video clips may be in a format that is not compatible with the mobile device. For example, some mobile devices have micro-browsers that use WAP only, yet many interesting Web sites with content designed particularly for those mobile devices use HTTP (Hypertext Transfer Protocol) instead.

Other reasons for which the mobile device may not be able to view the video clip may include, but are not limited to, the long download time and the expense associated with downloading large amounts of data using a slow data connection, slow processor speeds, limited available memory, etc. Even if the data is capable of being displayed on the mobile device, another downfall with browsing on a mobile device is the amount of scrolling that one has to do to see all of the information on a particular Web page due to the small screen size of the mobile device.

Thus, what is needed is an efficient system and method for enabling a mobile user to browse the Web and select content for the mobile device.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary system for browsing on behalf of others according to an embodiment of the invention.

FIG. 2 is a flow diagram illustrating a method for browsing on behalf of others according to an embodiment of the invention.

FIG. 3 is a flow diagram illustrating an alternative method for browsing on behalf of others according to an embodiment of the invention.

FIG. 4 is a flow diagram describing a method for over-the-air provisioning of content for a target device according to an embodiment of the invention.

FIG. 5 is a block diagram illustrating an exemplary computer system.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed towards systems and methods for browsing on behalf of others. Information regarding content and/or resources suitable for execution on a target (or first) device is presented on a browsing (or second) device in a manner suitable to the browsing device. This is accomplished by using two device profiles, one for the target device and the other for the device browsing on behalf of the target device. The target device profile is used to enable a content server to provide the desired content or resources in a format suitable for use on the target device. The profile for the device that is browsing on behalf of the target device is used to enable the content server to provide the browsing device with information regarding content and/or resources requested for the target device. This information may include, but is not limited to, content in which it is more convenient to display on the browsing device than on the target device as well as content that is incapable of being displayed on the target device. Thus, embodiments of the present invention enable one device's profile to obtain content that is appropriate on that device by another device whose profile is used for formatting and presentation purposes.

Although embodiments of the present invention are described for enabling a browsing device to browse on behalf of a mobile device, the invention is not limited to this implementation. One skilled in the relevant art(s) would know that other devices with browsing capabilities may browse on behalf of data processing devices other than mobile devices without departing from the scope of the invention.

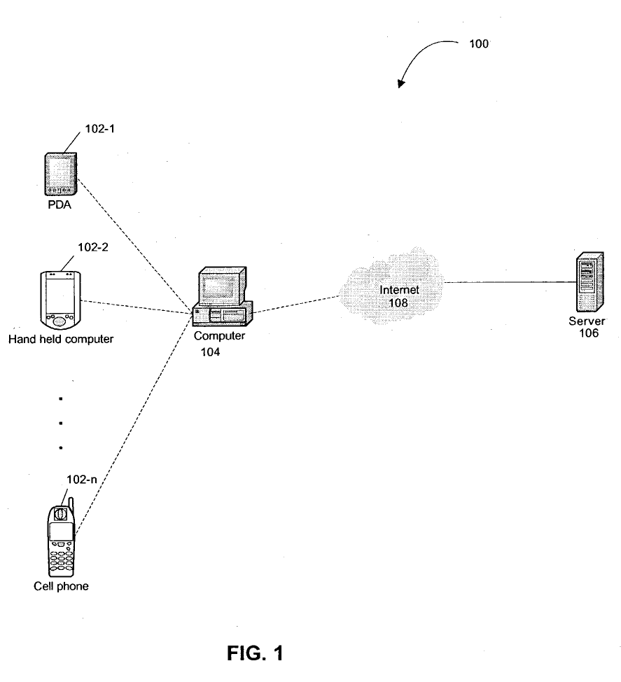

FIG. 1 is a block diagram illustrating an exemplary system 100 for browsing on behalf of others according to an embodiment of the present invention. System 100 comprises one or more mobile devices 102-1, 102-2, . . . , and 102-n, a browsing device 104, a content (or Web) server 106, and a wide area network (WAN) 108 such as, but not limited to, the Internet. Although the invention is described using a WAN (i.e., the Internet), other types of networks, such as intranets, local area networks (LANs), etc., may also be used. Mobile devices 102-1 . . . 102-n are intermittently connected to browsing device 104 (shown in phantom). For example, mobile device 102-1 may be connected to browsing device 104 using an adapter, such as a cradle (not shown), a wireless modem, Bluetooth or any other well-known connection means. Mobile devices 102-1 . . . 102-n usually connect to browsing device 104 during device profile transfers and during uploading of content. Browsing device 104 is intermittently connected to content server 106 (shown in phantom) over a wide area network, such as Internet 108. Browsing device 104 may be connected to content server 106 using dial-in connections, high-speed cable, digital subscriber lines (DSL), a local area network (LAN) connection, etc. Browsing device 104 usually connects to content server 106 during browsing sessions. Content server 106 may be connected to Internet 108 in any well-known manner. For example, content server 106 may be connected to Internet 108 by way of a router or a bridge via a local area network (LAN).

Mobile devices 102-1 . . . 102-n are typically handheld devices. For example, mobile device 102-1 is a personal digital assistant (PDA), mobile device 102-2 is a hand held computer, and mobile device 102-n is a cell phone. Mobile devices 102-1 . . . 102-n may be characterized as having relatively slow processor speeds, small memory size, a small display unit, and inconvenient input capabilities. For example, some mobile devices are characterized as having processor speeds of approximately 400 MHz, a memory size of 8 M bytes, a liquid crystal display unit approximately 3 inches×2.25 inches, and elementary input peripherals, such as a stylus and/or a touch screen for inputting data. Also, mobile devices 102-1 . . . 102-n typically use low bandwidth, relatively expensive network connections.

Browsing device 104 may be a personal computer (PC), such as a desktop or laptop computer, or any other device capable of browsing the Web on behalf of another device. Browsing device 104 may be characterized as having relatively fast processor speeds, large memory size, a large display unit, and sophisticated input peripherals. For example, many PCs are characterized as having processor speeds of 1.7 GHz or above, a memory size of 128 M bytes or more, a 17-inch flat panel display monitor, and sophisticated input peripherals, such as a keyboard and mouse. PCs typically use high-bandwidth, relatively inexpensive network connections. Browsing device 104 also includes a Web browser, such as, but not limited to, Microsoft® Internet Explorer by Microsoft Corporation and Navigator by Netscape.

Each of mobile devices 102-1 . . . 102-n and browsing device 104 must be capable of constructing profiles that include device capabilities and user preferences. This may be done using mechanisms such as, but not limited to, Composite Capabilities/Preferences Profiles (CCIPP) and User Agent Profile (UAProf). CC/PP and UAProf are resource description framework (RDF) based frameworks for describing and managing software and hardware profiles. The profiles include information on device capabilities (physical and programmatic), user specified preferences within the device's set of options, and specific qualities about the device that can affect content processing and display.

Retrievable content and/or resources from Internet 108 are hosted by content (or Web) server 106. Although embodiments of the invention are described using one content server, content server 106, the invention is not limited to one content server. Those skilled in the relevant art(s) would know that more than one content server can be used to retrieve content from Internet 108.

Content server 106 functions to send such retrievable content and/or resources from Internet 108 to the Web browser, on browsing device 104, using the Hypertext Transfer Protocol (HTTP). Content server 106 is able to determine the capabilities of the requesting device from user-agent headers, CC/PP and UAProf profile information, etc. Having knowledge of the capabilities of the requesting device enables content server 106 to customize the content and/or resources made available for that device, as well as the presentation of the content, based on the capabilities of that device.

In order for browsing device 104 to browse on behalf of any one of mobile devices 102-1 . . . 102-n, each mobile device (102-1 . . . 102-n) must convey its respective profile to browsing device 104. In one embodiment, each mobile device 102-1 . . . 102-n may convey its profile during a sync operation, in which information, such as e-mail, contacts, calendar, etc. is synchronized. The usage of the term “sync” as described herein refers to the overall operation of connecting a client to a server for the exchange, interaction, creation, and removal of data. In one embodiment, syncing can be defined as mirroring data on a client and a server, such that the data is the same on both the client and server. In other embodiments, syncing can be defined as overwriting data on a client or on a server, such that the data on either the client or the server replaces the data on the server or client, respectively. The sync operation may occur by inserting each of mobile devices 102-1 . . . 102-n into a cradle coupled to browsing device 104 (one at a time), or by using other means for coupling mobile devices 102-1 . . . 102-n to browsing device 104, such as Bluetooth, an infra-red (IR) port, wireless Ethernet, a USB (universal serial bus) connector, a serial port, etc. Other means for conveying the profiles of mobile devices 102-1 . . . 102-n to browsing device 104 may include, but are not limited to, coupling mobile devices 102-1 . . . 102-n to browsing device 104 via any one of Bluetooth, an infra-red (IR) port, wireless Ethernet, a USB cable, a serial cable, etc. and transferring the data (i.e., profiles) in a well-known manner.

In one embodiment, when browsing device 104 browses for content and/or resources on behalf of any one of mobile devices 102-1 . . . 102-n, browsing device 104 sends its own profile as well as the profile of the mobile device (102-1, . . . , or 102-n) that is requesting content. Alternatively, content server 106 may request the profiles, some parts of the profiles or other information describing device characteristics, such as, for example, installed software, using server queries. Content server 106 then processes the profiles, accesses the content, and tailors the content for both the mobile device (102-1, . . . , or 102-n) and browsing device 104, accordingly.

For example, when browsing device 104 browses a catalog of mobile applications for mobile device 102-1, content server 106 will use the profile for mobile device 102-1 in putting together a list of applications, games, and other executable content suitable for mobile device 102-1, taking into account the codecs, screen size, screen resolution, etc. of mobile device 102-1. However, content server 106 will use the profile of browsing device 104 to present information about the applications, games, and other executable content to the user. The profile of browsing device 104 can be used to decide the items to be presented, such as screen shots, links to samples, trailers, etc., as well as format the presentation based on the screen size, network connection, browser plug-ins, etc. of browsing device 104.

Thus, with embodiments of the present invention, the browsing experience of a mobile user is enhanced by the capabilities of browsing device 104, yet not restricted by the limitations of the browsing capabilities of mobile device 102-1. The user is given the ability to find the desired resources for their mobile device as if browsing on their mobile device, while using a more efficient setup for browsing through the use of a browsing device.

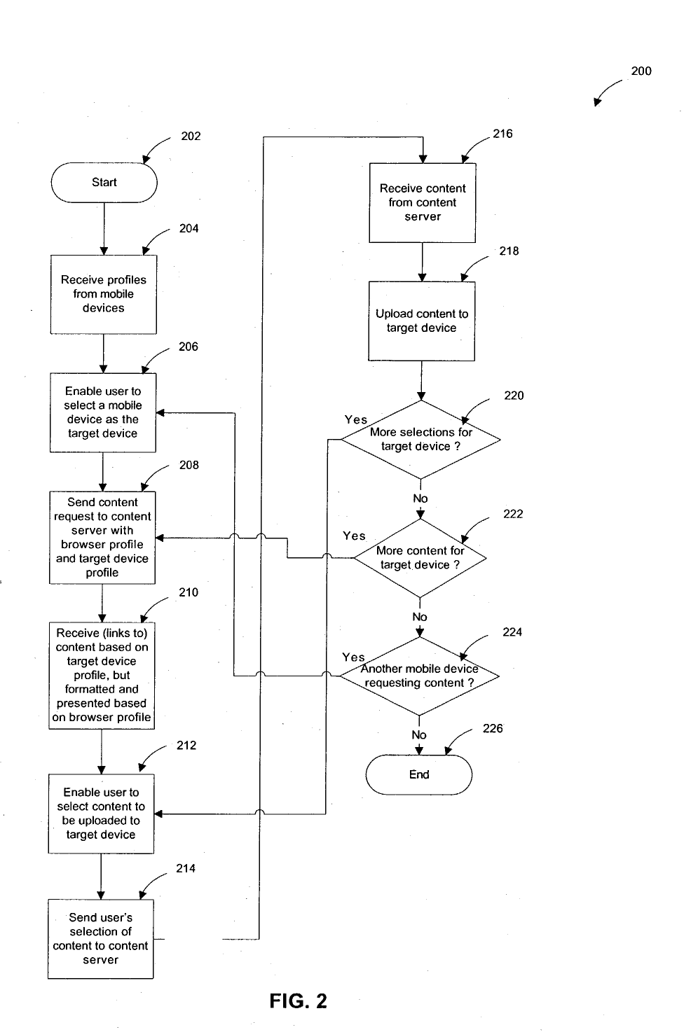

FIG. 2 is a flow diagram 200 describing a method for browsing on behalf of others according to an embodiment of the present invention. The invention is not limited to the embodiment described herein with respect to flow diagram 200. Rather, it will be apparent to persons skilled in the relevant art(s) after reading the teachings provided herein that other functional flow diagrams are within the scope of the invention. The process begins with block 202, where the process immediately proceeds to block 204.

In block 204, each of mobile devices 102-1 . . . 102-n sends its profile to browser device 104. The profiles may be CC/PP profiles or any other profiles that provide device characteristics in a standard format. As previously stated, the mobile device profiles may be sent to browser device 104 in several ways. In one embodiment, each mobile device 102-1 . . . 102-n may send its profile during a sync operation. In one embodiment, the sync operation may be accomplished by inserting each mobile device 102-1 . . . 102-n into a cradle that is coupled to browsing device 104. Data is then transferred between one mobile device (102-1, 102-2, . . . or 102-n) and browsing device 104 via HotSync technology. HotSync technology is well known to those skilled in the relevant art(s). In other embodiments, the sync operation may be accomplished by coupling mobile devices 102-1, 102-2, . . . , and 102-n to browsing device 104 using Bluetooth, infra-red (IR) ports, wireless Ethernet, a USB cable, a serial cable, etc. In other embodiments, the profiles of mobile devices 102-1, 102-2, . . . , and 102-n may be sent to browsing device 104 in a well-known manner using Bluetooth, IR ports, a USB cable, wireless Ethernet, a serial cable, or any other means for coupling mobile devices 102-1, 102-2, . . . , and 102-n to browsing device 104 for the transfer of data. In yet another embodiment of the invention, device profiles for mobile devices 102-1, 102-2, . . . , and 102-n may be sent to browsing device 104 using over-the-air (OTA) provisioning. For example, the user could browse to the manufacturer's Web site for mobile device (102-1, 102-2, . . . , or 102-n) and request that the device profile for that mobile device (102-1, 102-2, . . . , or 102-n) be sent to browsing device 104. The manufacturer, in turn, will download the mobile device profile to browsing device 104. In yet another embodiment, each of mobile devices 102-1, 102-2, . . . , and 102-n may send a link to their profile to browsing device 104. Browsing device 104, in turn, may send the link to content server 106 for the mobile device (102-1, 102-2, . . . , or 102-n) in which browsing is being performed. Using the link, content server 106 may then obtain the device profile over the Internet 108, where the link may point to the manufacturer's Web site or to a profile repository. Content server 106 may then convey the device profile to browsing device 104.

Upon receipt of the mobile device profiles, browsing device 104 stores the profiles in a database for each user.

Although device profiles are pretty much static, they may change if components of the device change. Example device changes may include, but are not limited to, adding memory to the device, adding a component to the device, such as a camera, a circuit card having Bluetooth capabilities, etc. Thus, if a change is detected in a device profile during a sync operation, the device profile will be updated. Embodiments in which sync operations are not used require that device profiles be updated periodically.

In block 206, a user is enabled to select one of mobile devices 102-1, 102-2, . . . , and 102-n as the mobile device on whose behalf browsing device 104 will browse for content. In one embodiment, a drop down menu listing each mobile device in which a profile exists on browsing device 104 is used to enable the user to make the selection. In another embodiment, the user is prompted with a list of all of the mobile devices for which browsing device 104 has a stored profile. The user is then required to highlight their selection in a well-known manner. Once a selection has been made, the selected mobile device is referred to as the target device to indicate on whose behalf browsing device 104 is browsing for content.

In block 208, browsing device 104 sends a content request to content server 106. The content request also includes the profile of the target device describing the desired content and the profile of the browser or browsing device 104 describing the desired presentation.

In block 210, browsing device 104 receives information concerning the requested content from content server 106. For example, if the target device requested games that can be played on the target device, the content that is received from content server 106 to be displayed on browsing device 104 may consist of a Web page comprising several game titles along with descriptions and video previews for each game title, media shots, screen shots, etc. Links to other Web sites may also be displayed. All of the information is formatted and presented using the browser profile.

In block 212, browsing device 104 enables the user to select the content desired for the target device. For example, returning to the above example, the user, after viewing some screen shots and video previews of games, may select a game to be downloaded to the target device.

In block 214, the user's content selection is sent to content server 106. In block 216, browsing device 104 receives the selected content, but this time the content is based on the profile of the target device.

In block 218, if the target device is connected to browsing device 104, the received content is automatically uploaded to the target device. If the target device is not connected to browsing device 104 at the time the content is received, browsing device 104 stores the content, and on a subsequent sync, the content is uploaded to the target device. Note that in one embodiment, the target device and browsing device 104 are always physically connected during a browsing session.

In block 220, it is determined whether more selections from the displayed Web pages in block 210 are desired by the user for the target device. If more selections are desired for the target device, the process proceeds back to block 212, to enable the user to select more content. Alternatively, if more selections are not desired for the target device, the process proceeds to block 222.

In block 222, it is determined whether more content is desired for the target device. More content may be obtained from content server 106 or from other content servers on Internet 108. If it is determined that more content is desired, the process proceeds back to block 208, to allow browsing device 104 to send another content request to content server 106. If it is determined that more content is not desired by the target device, the process proceeds to block 224.

In block 224, it is determined whether another mobile device would like to request content. If it is determined that another mobile device would like to request content, the process proceeds back to block 206 to enable the user to select another mobile device on whose behalf browsing device 104 will browse for content. If it is determined that the remaining mobile devices do not want to request content, the process proceeds to block 226, where the process ends.

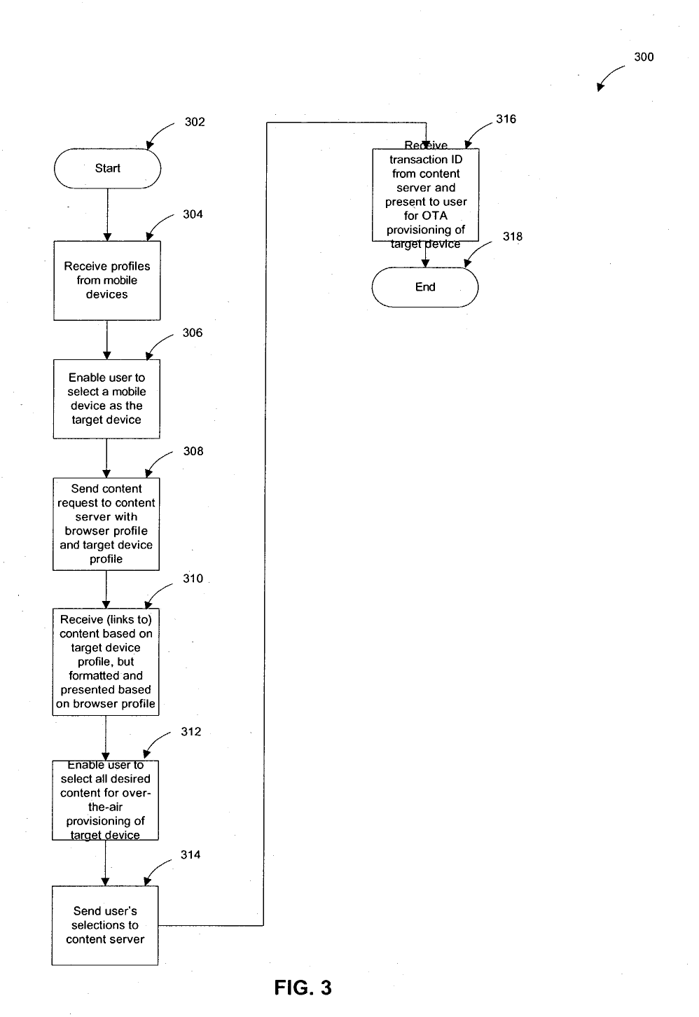

FIG. 3 is a flow diagram 300 describing another method for browsing on behalf of others according to an embodiment of the invention. The invention is not limited to the embodiment described herein with respect to flow diagram 300. Rather, it will be apparent to persons skilled in the relevant art(s) after reading the teachings provided herein that other functional flow diagrams are within the scope of the invention. The process of flow diagram 300 is similar to the process of flow diagram 200 in many respects, except that content intended for the target device is downloaded using over-the-air provisioning. The process begins with block 302, where the process immediately proceeds to block 304.

In block 304, each of mobile devices 102-1 . . . 102-n sends its profile to browser device 104. This is done in a manner similar to that recited above with reference to FIG. 2, block 204.

In block 306, a user is enabled to select one of mobile devices 102-1, 102-2, . . . , and 102-n as the mobile device on whose behalf browsing device 104 will browse for content in a manner similar to that recited in FIG. 2, block 206.

In block 308, browsing device 104 sends a content request to content server 106. The content request also includes the profile of the target device describing the desired content and the profile of the browser or browsing device 104 describing the desired presentation.

In block 310, browsing device 104 receives information concerning the requested content from content server 106 in a similar manner as that recited in FIG. 2, block 210.

In block 312, browsing device 104 enables the user to select all of the desired content for over-the-air provisioning of the target device. The user selections are then sent to content server 106 in block 314.

In block 316, browser device 104 receives a transaction ID (identifier) from content server 106, and presents the transaction ID to the user for enabling the over-the-air provisioning of the selected content to the target device.

In an alternative embodiment, content server 106 may be provided with enough information from the target profile, login, and/or account information to perform over-the-air provisioning directly. In this case, the transaction ID is not used. Instead, content server 106, after receiving the desired user selections from browsing device 104, sends the selected content over-the-air to the target device directly.

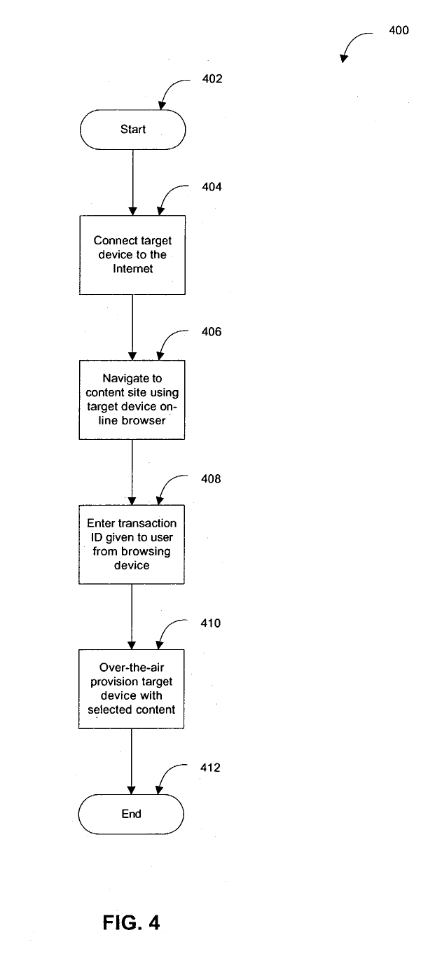

FIG. 4 is a flow diagram 400 describing a method for over-the-air provisioning of content for a target device when a transaction ID is used according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, the target device is connected to Internet 108. The user may connect to Internet 108 using a wireless connection, such as a wireless modem, by dialing into an Internet service provider. Once connected to Internet 108, the user may navigate to the desired content site by typing in its location into the browser (block 406). Once the page has been downloaded, the user may enter the transaction ID when prompted (block 408). Upon entry of the transaction ID, the target device is over-the-air provisioned with the selected content (block 410).

In yet another embodiment of the present invention, mobile device 102-1, for example, and browsing device 104 may be integrated on the same physical device, but have platforms whose capabilities may be described by one or more profiles depending upon the power level or other modality in which the platform runs. In this embodiment, the device profiles may be created by the user or may be available from the manufacturer. Such profiles may include a normal power profile, a power saving profile, a wireless networking profile, etc. So, for example, if a user would like to find content that when executed will not drain the battery of the device, the user could look for content using a power saving profile, and request that the content be presented using a normal power mode profile.

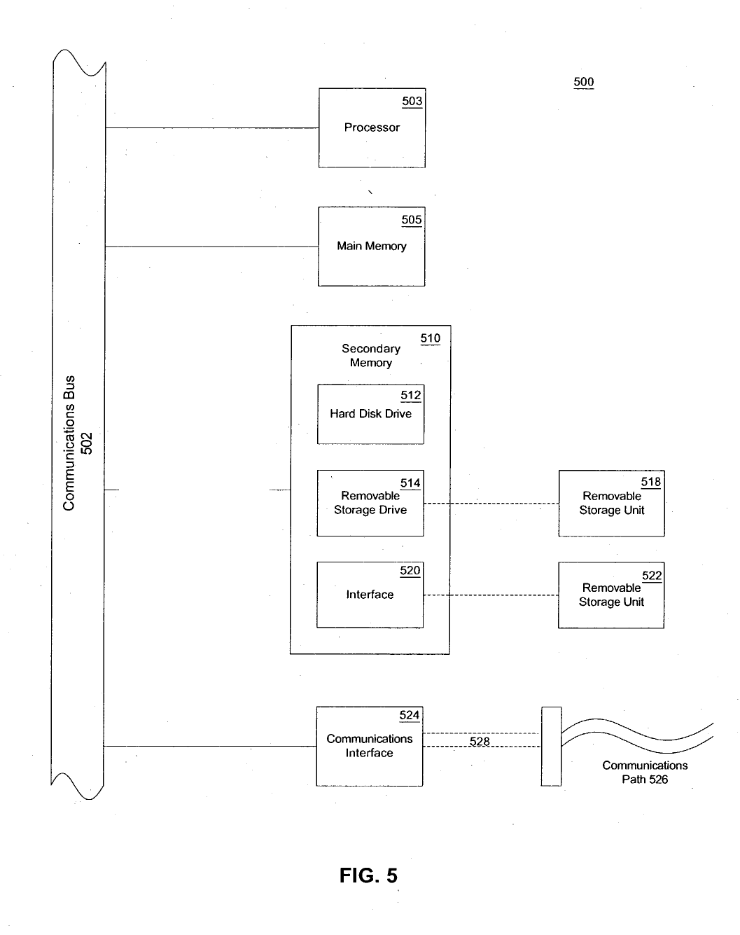

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 500 is shown in FIG. 5. Various embodiments are described in terms of this exemplary computer system 500. After reading this description, it will be apparent to a person skilled in the relevant art how to implement the invention using other computer systems and/or computer architectures.

Computer system 500 includes one or more processors, such as processor 503. Processor 503 is connected to a communication bus 502. Computer system 500 also includes a main memory 505, preferably random access memory (RAM), and may also include a secondary memory 510. Second memory 510 may include, for example, a hard disk drive 512 and/or a removable storage drive 514, representing a floppy disk drive, a magnetic tape drive, an optical disk drive, etc. Removable storage drive 514 reads from and/or writes to a removable storage unit 518 in a well-known manner. Removable storage unit 518 represents a floppy disk, magnetic tape, optical disk, etc., which is read by and written to by removable storage drive 514. As will be appreciated, removable storage unit 518 includes a computer usable storage medium having stored therein computer software and/or data.

In alternative embodiments, secondary memory 510 may include other similar means for allowing computer programs or other instructions to be loaded into computer system 500. Such means may include, for example, a removable storage unit 522 and an interface 520. Examples of such may include a program cartridge and cartridge interface (such as that found in video game devices), a removable memory chip (such as an EPROM (erasable programmable read-only memory) or PROM (programmable read-only memory)) and associated socket, and other removable storage units 522 and interfaces 520 which allow software and data to be transferred from removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a PCMCIA (personal computer memory card international association) slot and card, a wireless LAN (local area network) interface, etc. Software and data transferred via communications interface 524 are in the form of signals 528 which may be electronic, electromagnetic, optical or other signals capable of being received by communications interface 524. These signals 528 are provided to communications interface 524 via a communications path (i.e., channel) 526. Channel 526 carries signals 528 and may be implemented using wire or cable, fiber optics, a phone line, a cellular phone link, a wireless link, and other communications channels.

In this document, the term “computer program product” refers to removable storage units 518, 522, and signals 528. These computer program products are means for providing software to computer system 500. Embodiments of the invention are directed to such computer program products.

Computer programs (also called computer control logic) are stored in main memory 505, and/or secondary memory 510 and/or in computer program products. Computer programs may also be received via communications interface 524. Such computer programs, when executed, enable computer system 500 to perform the features of the present invention as discussed herein. In particular, the computer programs, when executed, enable processor 503 to perform the features of embodiments of the present invention. Accordingly, such computer programs represent controllers of computer system 500.

In an embodiment where the invention is implemented using software, the software may be stored in a computer program product and loaded into computer system 500 using removable storage drive 514, hard drive 512 or communications interface 524. The control logic (software), when executed by processor 503, causes processor 503 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A method for enabling a browsing device to browse on behalf of others, comprising:
sending a content request to a content server, wherein the content request includes a target device profile and a browser profile;
receiving a response from the content server, wherein the response is formatted for presentation based on the browser profile;
enabling a user to select content presented in the response for the target device;
receiving the selected content in a format based on the profile of the target device; and
uploading the received content to the target device.

2. The method of claim 1, further comprising:
receiving one or more profiles from one or more devices prior to sending a content request; and
enabling the user to select one device from the one or more devices as the target device, wherein the target device indicates the device on whose behalf browsing is being performed.

3. The method of claim 1, wherein said target device comprises a mobile device.

4. The method of claim 1, wherein the target device profile and the browser profile comprise CC/PP (composite capabilities/preferences profiles) profiles.

5. The method of claim 1, wherein the content request comprises a request for at least one of content and resources for execution on the target device based on the target device profile.

6. The method of claim 1, wherein the response from the content server includes one or more Web pages comprising at least one of titles, content information, links to content, video previews, media shots, and screen shots.

7. The method of claim 1, wherein enabling the user to select content presented in the response for the target device further comprises sending the content selection to the content server.

8. The method of claim 1, wherein the browser profile describes the desired presentation of the content request.

9. The method of claim 1, wherein uploading the received content to the target device occurs during a sync operation.

10. A method for browsing on behalf of others, comprising:
sending a content request to a server, the content request comprising a request for at least one of content and resources suitable for execution on a target device, a browser profile, and a target device profile, the browser profile for enabling the server to return information regarding the requested content and resources for display by a browsing device, the target device profile for enabling the server to return downloadable content to the browsing device corresponding to the information regarding the requested content and resources in a format suitable for execution on the target device;
receiving the information regarding the requested content and/or resources in the form of Web pages; and
enabling a user to select desired content presented on the Web pages to be over-the-air provisioned to the target device.

11. The method of claim 10, further comprising:
receiving a transaction identifier (ID) from the content server; and
enabling over-the-air provisioning of the desired content to the target device by presenting the transaction ID to the user, wherein the user connects the target device to the Internet using a wireless connection, navigates to the desired Web site, and enters the transaction ID, wherein the entry of the transaction ID into the Web site causes the over-the-air provisioning of the desired content to the target device.

12. The method of claim 10, wherein the target profile, login, and account information are sufficient to enable the content server to directly over-the-air provision the desired content to the target device.

13. A system for browsing on behalf of others, comprising:
a plurality of data processing devices, each of the data processing devices having a device profile;
a browsing device to browse on behalf of one or more of the plurality of data processing devices, the browsing device having a browsing device profile; and
at least one server, wherein the at least one server hosts retrievable at least one of content and resources from the Internet to send the retrievable content and resources to a Web browser on the browsing device, wherein information regarding the retrievable content and resources is sent to the browsing device in a format based on the browsing device profile for presentation purposes and the retrievable content and resources is sent to the browsing device in a format based on the device profile of the one or more of the plurality of processing devices to be uploaded to the one or more of the plurality of processing devices.

14. The system of claim 13, wherein the browsing device comprises one of a personal computer and a laptop computer.

15. The system of claim 13, wherein the plurality of data processing devices include mobile devices.

16. An article comprising: a storage medium having a plurality of machine accessible instructions, wherein when the instructions are executed by a processor, the instructions provide for sending a content request to a content server, wherein the content request includes a target device profile and a browser profile;
receiving a response from the content server, wherein the response is formatted for presentation based on the browser profile;
enabling a user to select content presented in the response for the target device;
receiving the selected content in a format based on the profile of the target device; and
uploading the received content to the target device.

17. The article of claim 16, further comprising:
receiving one or more profiles from one or more devices prior to sending a content request; and
enabling the user to select one device from the one or more devices as the target device, wherein the target device indicates the device on whose behalf browsing is being performed.

18. The article of claim 16, wherein said target device comprises a mobile device.

19. The article of claim 16, wherein the target device profile and the browser profile comprise CC/PP (composite capabilities/preferences profiles) profiles.

20. The article of claim 16, wherein the content request comprises a request for at least one of content and resources for execution on the target device based on the target device profile.

21. The article of claim 16, wherein the response from the content server includes one or more Web pages comprising at least one of titles, content information, links to content, video previews, media shots, and screen shots.

22. The article of claim 16, wherein enabling the user to select content presented in the response for the target device further comprises sending the content selection to the content server.

23. The article of claim 16, wherein the browser profile describes the desired presentation of the content request.

24. The article of claim 16, wherein uploading the received content to the target device occurs during a sync operation.

25. An article comprising: a storage medium having a plurality of machine accessible instructions, wherein when the instructions are executed by a processor, the instructions provide for sending a content request to a server, the content request comprising a request for at least one of content and resources suitable for execution on a target device, a browser profile, and a target device profile, the browser profile for enabling the server to return information regarding the requested content and resources for display by a browsing device, the target device profile for enabling the server to return downloadable content to the browsing device corresponding to the information regarding the requested content and resources in a format suitable for execution on the target device;
receiving the information regarding the requested content and/or resources in the form of Web pages; and
enabling a user to select desired content presented on the Web pages to be over-the-air provisioned to the target device.

26. The article of claim 25, further comprising:
receiving a transaction identifier (ID) from the content server; and
enabling over-the-air provisioning of the desired content to the target device by presenting the transaction ID to the user, wherein the user connects the target device to the Internet using a wireless connection, navigates to the desired Web site, and enters the transaction ID, wherein the entry of the transaction ID into the Web site causes the over-the-air provisioning of the desired content to the target device.

27. The article of claim 25, wherein the target profile, login, and account information are sufficient to enable the content server to directly over-the-air provision the desired content to the target device.
